(19) United States
(12) Patent Application Publication
(10) Pub. No.: US 2021/0296024 A1
(43) Pub. Date: Sep. 23, 2021

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: A-NAN YANG, Huaian (CN); HAN-RUN XIE, Huaian (CN); LU-YU CHANG, New Taipei (TW)

(21) Appl. No.: 17/201,339

(22) Filed: Mar. 15, 2021

(30) Foreign Application Priority Data
Mar. 17, 2020 (CN) 202020330746.X

(51) Int. Cl. H01B 7/02

(52) U.S. Cl. CPC H01B 7/0241; H01B 7/025; H01B 7/225; H01B 7/0225; H01B 7/0283

(57) ABSTRACT

A cable includes a pair of core wires, a shielding layer covering the pair of core wires, and an outer insulating layer covering the shielding layer, wherein each of the pair of core wires includes an inner conductor and an insulating layer spirally wound around the inner conductor, the insulating layer includes at least two layers, and winding directions of adjacent insulating layers are different.

### BACKGROUND OF THE INVENTION

### 1. Field of the Invention

The present invention relates generally to a cable, and more particularly to a cable that is resistant to bending.

### 2. Description of Related Arts

With the development and popularization of electronic technology products, signal cables are widely used in household appliances, instrumentation, automation equipment, data centers, servers, switches, cloud computing and 5G as a tool for signal transmission. However, with the development of equipment becoming more and more integrated and miniaturized, the space for installing cables is getting smaller and smaller. In the process of use, cables are very susceptible to the limitation of installation space.

Therefore, it is desired to provide an improved cable with good bending resistance.

### SUMMARY OF THE INVENTION

A main object of the present invention is to provide a cable which is resistant to bending.

To achieve the above-mentioned object, a cable comprises a pair of core wires, a shielding layer covering the pair of core wires, and an outer insulating layer covering the shielding layer, wherein each of the pair of core wires includes an inner conductor and an insulating layer spirally wound around the inner conductor, the insulating layer includes at least two layers, and winding directions of adjacent insulating layers are different.

Compared to the prior art, the present invention has the advantage that the insulating layer is spirally wound outside the inner conductor, making the cable more flexible and resistant to bending. The cable of the present invention also has the ability to transmit high-speed data signals with a frequency greater than 20 GHz.

### BRIEF DESCRIPTION OF THE DRAWING

FIG. 1 is a cross-section view of the first embodiment of the cable of the present invention; and

FIG. 2 is a cross-section view of the second embodiment of the cable of the present invention.

### DETAILED DESCRIPTION OF THE PREFERRED EMBODIMENT

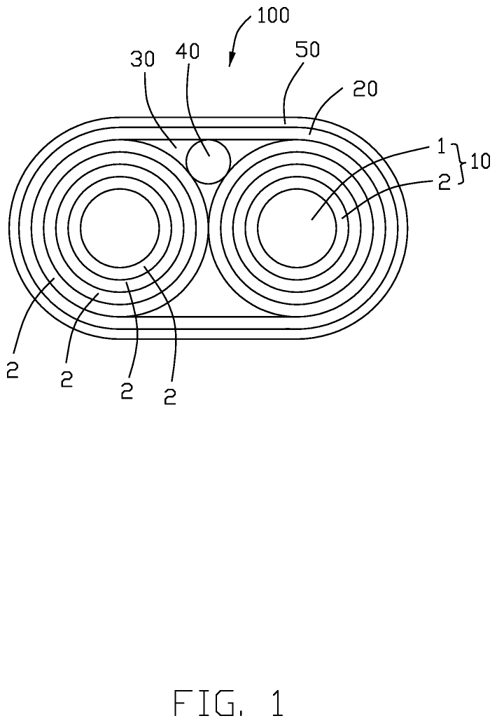

FIG. 1 shows an embodiment of a cable 100 of the present invention. The cable 100 includes two core wires 10, a shielding layer 20 covers the two core wires 10, an outer insulating layer 50 covers the shielding layer 20, and a ground wire 40 between the two core wires 10 and the shielding layer 20.

In this embodiment, the two core wires 10 are contact with each other and extend in the longitudinal direction. Each of the core wire 10 includes an inner conductor 1 and an insulating layer 2 covering the inner conductor 1. The insulating layer 2 can be provided as one layer or multiple layers, and the number of the insulating layer 2 can be increased or decreased according to impedance requirements. The insulating layer 2 of each core wire 10 is spirally wound to cover the respective inner conductor 1. When the insulating layer 2 is provided as multiple layers, the winding directions of two adjacent insulating layers 2 are not the same. The outermost insulating layers 2 of the two core wires 10 are in contact with each other. The insulating layer 2 is selected from the group including E-PTFE (expanded Polytetrafluoroethylene) and PTFE (polytetrafluoroethylene). The shielding layer 20 is covers the two core wires 10 in a longitudinal manner. The shielding layer 20 is selected from the aluminum foil (AL/PET), the copper foil (Cu/PET), pure copper tape and pure aluminum tape. The outer insulating layer 50 can be provided as one layer or multiple layers. In this embodiment, the outer insulating layer 50 is provided as one layer, which is made of PET. The outer insulating layer 50 is wrapped around the shielding layer 20 in a spiral winding manner. An air gap 30 is formed between the two core wires 10 and the shielding layer, and the ground wire 40 is located in the air gap 30.

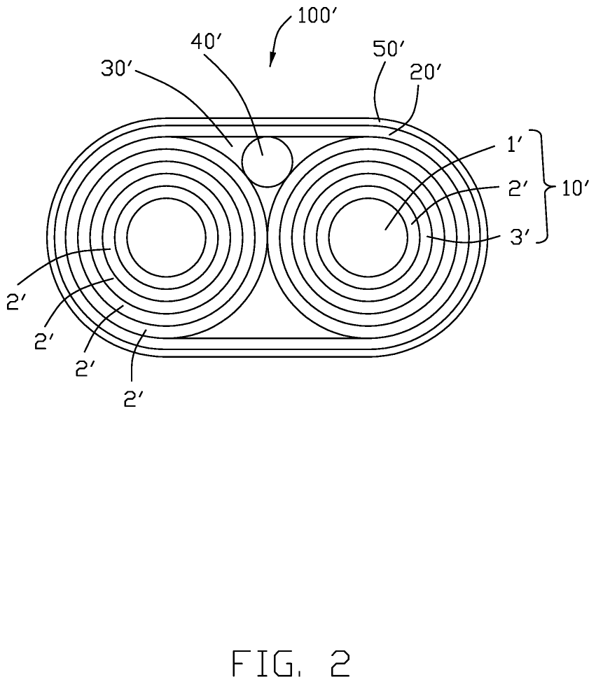

Referring to FIG. 2, which is the second embodiment of the cable 100′ of the present invention. The cable 100′ comprises two core wires 10′, a shielding layer 20′ covering the two core wires 10′, an outer insulating layer 50′ covering the shielding layer 20′, and a ground wire 40′ located in the air gap 30′ between the two core wires 10′ and the shielding layer 20′. Compared with the first embodiment, in this embodiment, an inner insulating layer 3′ extruded and formed outside the inner conductor 1′ is added between the inner conductor 1′ and the insulating layer 2′ of the core wire 10′. The other composition and structure are the same as the first embodiment.

The cable of the present invention uses the insulating layer in the form of winding, which makes the cable more flexible and resistant to bending in order to meet the requirements of limited internal space such as a chassis. At the same time, the cable of the present invention has high-speed data transmission capability, provides more options for improving the high frequency characteristics of cables, and is adapted to current high-speed development of high-speed cables.

The above describes only some of the embodiments of the present invention, but not all of the embodiments. Any equivalent changes to the technical solutions of the present invention by those skilled in the art by reading the description of the present invention are covered by the claims of the present invention.

What is claimed is:

1. A cable comprising:
a pair of core wires;
a shielding layer covering the pair of core wires; and
an outer insulating layer covering the shielding layer; wherein
each of the pair of core wires includes an inner conductor and an insulating layer spirally wound around the inner conductor, the insulating layer includes at least two layers, and winding directions of adjacent insulating layers are different.

2. The cable as claimed in claim 1, wherein the surfaces of the pair of core wires are in contact with each other.

3. The cable as claimed in claim 2, wherein the outer insulating layer is only set as one layer.

4. The cable as claimed in claim 3, further comprising an inner insulating layer extruded outside the inner conductor and located between the inner conductor and the insulating layer.

5. The cable as claimed in claim 4, wherein the insulating layer and the inner insulating layer are selected from the group consisting of EPTFE and PTFE.

6. The cable as claimed in claim 1, wherein the shielding is selected from the group consisting of aluminum foil tape, copper foil tape, pure copper tape, and pure aluminum tape.

7. The cable as claimed in claim 6, wherein the shielding layer covers the core wires in a longitudinally wrapped manner.

8. The cable as claimed in claim 7, further comprising a ground wire arranged between the shielding layer and the core wires.

9. The cable as claimed in claim 8, wherein the outer insulating layer covers the shielding layer in a spiral winding manner.
